(19) United States
(12) Patent Application Publication
(10) Pub. No.: US 2024/0123663 A1
(43) Pub. Date: Apr. 18, 2024

(54) INJECTION DEVICE AND CONTROL METHOD

(71) Applicant: FANUC CORPORATION, FANUC CORPORATION (CN)

(72) Inventors: Takuya OSAWA, Minamitsuru-gun, Yamanashi-ken (JP); Shoutarou SEKIGUCHI, Minamitsuru-gun, Yamanashi-ken (JP)

(21) Appl. No.: 18/273,206

(22) PCT Filed: Jan. 20, 2022
(86) PCT No.: PCT/JP2022/001946

§ 371 Date: Jul. 19, 2023

(30) Foreign Application Priority Data
Jan. 29, 2021 (JP) 2021-013451

(51) Int. Cl. B29C 45/50; B29C 45/76

(52) U.S. Cl. CPC B29C 45/50; B29C 45/76; B29C 2045/504

(57) ABSTRACT

In an injection device according to an embodiment, each of a plurality of outer peripheral protrusions of a screw is formed with an outer peripheral protrusion inclined surface, and each of a plurality of inner peripheral protrusions of a through-hole of a bush is formed with an inner peripheral protrusion inclined surface. The injection device advances the bush until a linear-motion torque exceeds a linear-motion torque threshold, and, if a rotation torque exceeds a rotation torque threshold before the linear-motion torque exceeds the linear-motion torque threshold, ends control processing when the linear-motion torque exceeds the linear-motion torque threshold.

### TECHNICAL FIELD

The present invention relates to an injection device and a control method.

### BACKGROUND ART

JP 2019-055488 A discloses a motor control unit that controls a linear motion motor and a rotational motion motor. The linear motion motor is a motor for moving a bush in the axial direction of a screw. The rotational motion motor is a motor for rotating the bush around the axis of the screw.

The motor control unit controls the linear motion motor to move the bush forward in a direction of approaching the screw from a state of being separated from the screw. When the torque of the linear motion motor has become equal to or greater than a first torque during the forward movement of the bush, the motor control unit controls the rotational motion motor to rotate the bush.

### SUMMARY OF THE INVENTION

In JP 2019-055488 A, two cases are conceivable as a case where the torque of the linear motion motor becomes equal to or greater than the first torque. The first case is a case where the spline shaft and the spline hole are not fitted to each other and the bush is in contact with the screw. The second case is a case where, when the bush fitted to the spline shaft continues to move forward and the spline shaft comes into contact with the bottom surface of the spline hole.

However, in JP 2019-055488 A, it is assumed that the spline shaft and the spline hole are not fitted to each other and the bush is in contact with the screw. For this reason, in JP 2019-055488 A, in a case that the bush fitted to the spline shaft continues to move forward and the spline shaft comes into contact with the bottom surface of the spline hole, the operation of rotating the bush is wasted.

It is therefore an object of the present invention to provide an injection device and a control method capable of enhancing the working efficiency for spline fitting.

A first aspect of the of the present invention, there is provided an injection device including a screw disposed along a forward and rearward direction including a forward direction in which an injection resin is injected and a rearward direction opposite to the forward direction, and a bush formed so as to be spline-fitted to the screw, the injection device causing the screw and the bush to be spline-fitted to each other, the injection device further including: a linear motion motor configured to move the bush forward and rearward in the forward and rearward direction with respect to the screw; a rotary motor configured to rotate the bush with respect to the screw; a first detection unit configured to detect a linear motion torque of the linear motion motor; a second detection unit configured to detect a rotational torque of the rotary motor; and a motor control unit configured to execute a control process of controlling the linear motion motor and the rotary motor while monitoring the linear motion torque and the rotational torque in a manner so that the bush is spline-fitted to the screw, wherein the screw includes a plurality of outer peripheral projections formed on an outer peripheral surface on a rear end side of the screw, the outer peripheral projections extending along the forward and rearward direction and being formed at intervals in a circumferential direction of the screw, each of the outer peripheral projections is formed with an outer peripheral projection inclined surface inclined in a manner so that an outer peripheral projection width along the circumferential direction of the screw becomes smaller toward a rear end, the bush includes a through hole extending in the forward and rearward direction, and a plurality of inner peripheral projections formed on an inner peripheral surface of the through hole, the inner peripheral projections extending in the forward and rearward direction and being formed at intervals in a circumferential direction of the through hole, each of the inner peripheral projections is formed with an inner peripheral projection inclined surface inclined in a manner so that an inner peripheral projection width along the circumferential direction of the through hole becomes smaller toward a front end, and the motor control unit moves the bush forward until the linear motion torque exceeds a linear motion torque threshold, and in a case where the rotational torque exceeds a rotational torque threshold before the linear motion torque exceeds the linear motion torque threshold, the motor control unit ends the control process when the linear motion torque exceeds the linear motion torque threshold.

According to a second aspect of the present invention, there is provided a control method executed by an injection device, the injection device including: a screw disposed along a forward and rearward direction including a forward direction in which an injection resin is injected and a rearward direction opposite to the forward direction; a bush formed so as to be spline-fitted to the screw; a linear motion motor configured to move the bush forward and rearward in the forward and rearward direction with respect to the screw; a rotary motor configured to rotate the bush with respect to the screw; a first detection unit configured to detect a linear motion torque of the linear motion motor; and a second detection unit configured to detect a rotational torque of the rotary motor, and in the control method, the injection device controls the linear motion motor and the rotary motor while monitoring the linear motion torque and the rotational torque in a manner so that the screw and the bush are spline-fitted to each other, the control method including: a forward movement step of moving the bush forward until the linear motion torque exceeds a linear motion torque threshold; a forward movement stopping step of, in a case where the rotational torque exceeds a rotational torque threshold before the linear motion torque exceeds the linear motion torque threshold, stopping forward movement of the bush when the linear motion torque exceeds the linear motion torque threshold, wherein the screw includes a plurality of outer peripheral projections formed on an outer peripheral surface on a rear end side of the screw, the outer peripheral projections extending along the forward and rearward direction and being formed at intervals in a circumferential direction of the screw, each of the outer peripheral projections is formed with an outer peripheral projection inclined surface inclined in a manner so that an outer peripheral projection width along the circumferential direction of the screw becomes smaller toward a rear end, the bush includes a through hole, and a plurality of inner peripheral projections formed on an inner peripheral surface of the through hole, the inner peripheral projections extending in the forward and rearward direction and being formed at intervals in a circumferential direction of the through hole, and each of the inner peripheral projections is formed with an inner peripheral projection inclined surface inclined in a manner so that an inner peripheral projection width along the circumferential direction of the through hole becomes smaller toward a front end.

According to the aspects of the present invention, the spline fitting can be performed by rotating at least one of the bush or the screw by a guiding action of the outer peripheral projection inclined surface or the inner peripheral projection inclined surface while moving at least one of the bush or the screw forward. Further, it is possible to grasp that the spline fitting is being performed by such a guiding action, based on the rotational torque. Therefore, the spline fitting can be performed without wastefully rotating the bush, and as a result, the working efficiency for the spline fitting can be enhanced.

### BRIEF DESCRIPTION OF DRAWINGS

FIG. 1 is a schematic view showing an injection device according to an embodiment;

FIG. 2 is a view showing a screw and a bush;

FIG. 3 is a flowchart illustrating a procedure of a control process executed by the motor control unit in order to perform spline-fitting of the screw to the bush;

FIG. 4 is a view showing a state in which a rear end of an outer peripheral projection of the screw and a front end of an inner peripheral projection of the bush are in contact with each other;

FIG. 5 is an enlarged view of a contact portion between the rear end of the outer peripheral projection and the front end of the inner peripheral projection in FIG. 4;

FIG. 6 is a view showing a screw and a bush according to a first modification;

FIG. 7 is a view showing a screw and a bush according to a second modification;

FIG. 8 is a view showing a screw and a bush according to a third modification;

FIG. 9A is a cross sectional view of the screw of FIG. 8;

FIG. 9B shows a cross sectional view of the bush of FIG. 8;

FIG. 10 is a view showing a screw and a bush according to a fourth modification.

### DETAILED DESCRIPTION OF THE INVENTION

### Embodiment

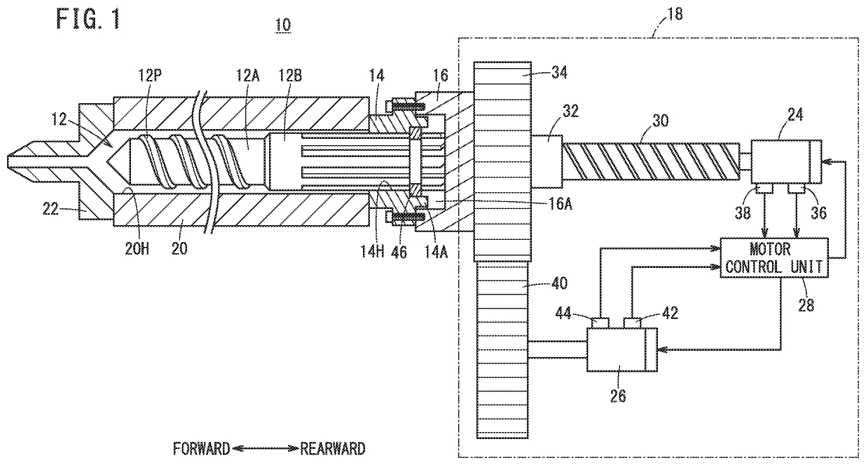

FIG. 1 is a schematic diagram illustrating an injection device 10 according to an embodiment. The injection device 10 injects a molding resin into a mold. In the present embodiment, an injection direction in which the molding resin is injected is a forward direction, and a direction opposite to the injection direction is a rearward direction. The injection device 10 includes a screw 12, a bush 14, a bush fastening portion 16, and a drive mechanism 18.

The screw 12 is accommodated in a through hole 20H of a cylinder 20. The screw 12 rotates to deliver, in the forward direction, the molding resin fed into the through hole 20H. The cylinder 20 includes, at a front end thereof, a nozzle 22, and the molding resin delivered by the screw 12 is injected from the nozzle 22. The screw 12 has a screw portion 12A and a spline portion 12B.

The screw portion 12A is a front portion of the screw 12. A helical protrusion 12P is formed on the outer peripheral surface of the screw portion 12A. The spline portion 12B is a rear portion of the screw 12 and is connected to a rear end of the screw portion 12A. The outer peripheral surface of the spline portion 12B is formed with concavities and convexities that can be spline-fitted to the bush 14.

The bush 14 is spline-fitted to the screw 12. The bush 14 has a through hole 14H extending therethrough in the forward and rearward direction. The inner peripheral surface of the through hole 14H is formed with concavities and convexities that can be spline-fitted to the spline portion 12B. The bush 14 is provided with an annular protrusion 14A protruding rearward from the rear end surface of the bush 14.

The bush fastening portion 16 fixes the bush 14 at the rear of the bush 14. The bush fastening portion 16 has a recess 16A in which the protrusion 14A of the bush 14 is accommodated. The bush 14 is fixed to the bush fastening portion 16 by using bolts, and the protrusion 14A is housed in the recess 16A.

The drive mechanism 18 is a mechanism that drives at least one of the screw 12 or the bush 14 so as to move the bush 14 relative to the screw 12. In the present embodiment, the drive mechanism 18 drives the bush 14. The drive mechanism 18 includes a linear motion motor 24, a rotary motor 26, and a motor control unit 28.

The linear motion motor 24 is a motor that moves the bush 14 forward and rearward in the forward and rearward direction. A ball screw 30 is coupled to the motor shaft of the linear motion motor 24, and rotates together with the motor shaft. A sliding portion 32 is attached to the ball screw 30 such that the ball screw 30 can move forward and rearward in the forward and rearward direction in accordance with the rotation of the linear motion motor 24. A linear motion gear 34 is rotatably attached to the sliding portion 32. The linear motion gear 34 is fixed to the rear end of the bush fastening portion 16. The linear motion motor 24 is provided with an encoder 36 that detects a rotation angle of the linear motion motor 24 and a first detection unit 38 that detects a linear motion torque of the linear motion motor 24.

The rotary motor 26 is a motor that rotates the bush 14. A rotation gear 40 meshing with the linear motion gear 34 is coupled to the motor shaft of the rotary motor 26. The rotary motor 26 is provided with an encoder 42 for detecting a rotation angle of the rotary motor 26 and a second detection unit 44 for detecting a rotational torque of the rotary motor 26.

In the drive mechanism 18, when the linear motion motor 24 rotates, the linear motion gear 34 moves in the forward and rearward direction via the ball screw 30 and the sliding portion 32 in accordance with the rotation of the linear motion motor 24. In this case, the rotation gear 40 meshing with the linear motion gear 34 and the rotary motor 26 move in the forward and rearward direction, and the bush 14 moves in the forward and rearward direction via the bush fastening portion 16 to which the linear motion gear 34 is fixed. On the other hand, when the rotary motor 26 rotates, the rotation gear 40 rotates in accordance with the rotation of the rotary motor 26. In this case, the linear motion gear 34 meshing with the rotation gear 40 rotates, and the bush 14 rotates via the bush fastening portion 16 to which the linear motion gear 34 is fixed.

The motor control unit 28 controls the linear motion motor 24 such that the rotation angle detected by the encoder 36 becomes a target value, thereby moving the bush 14 forward and rearward. The motor control unit 28 rotates the bush 14 by controlling the rotary motor 26 such that the rotation angle detected by the encoder 42 becomes a target value.

The motor control unit 28 executes a control process for controlling the linear motion motor 24 and the rotary motor 26 such that the bush 14 is spline-fitted to the screw 12. In this case, the motor control unit 28 controls the linear motion motor 24 and the rotary motor 26 while monitoring the linear motion torque detected by the first detection unit 38 and the rotational torque detected by the second detection unit 44.

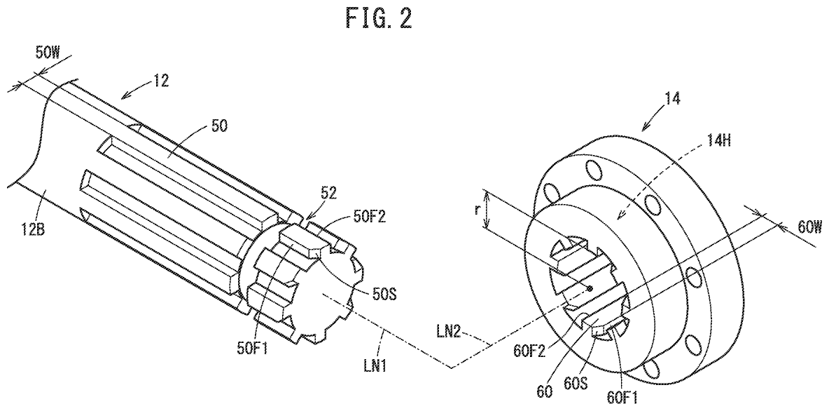

FIG. 2 is a view showing the screw 12 and the bush 14. The spline portion 12B includes a plurality of outer peripheral projections 50 formed on an outer peripheral surface of the spline portion. The projections 50 extend along the forward and rearward direction and are formed at intervals in the circumferential direction of the spline portion 12B. Each of the outer peripheral projections 50 is divided by a fitting groove 52 which extends along and around the circumferential direction of the spline portion 12B. An annular retainer 46 (FIG. 1) is fitted into the fitting groove 52.

The outer peripheral projections 50 have the same shape. Hereinafter, the shape of only one of the outer peripheral projections 50 will be described. An outer peripheral projection inclined surface 50S is formed at a rear end portion of one of both side surfaces 50F1 and 50F2 of the outer peripheral projection 50 in the circumferential direction of the screw 12. The outer peripheral projection inclined surface 50S is inclined such that an outer peripheral projection width 50W along the circumferential direction of the screw 12 becomes smaller toward the rear end.

The through hole 14H of the bush 14 includes a plurality of inner peripheral projections 60 formed on an inner peripheral surface of the through hole 14H. The inner peripheral projections extend along the forward and rearward direction and are formed at intervals in the circumferential direction of the through hole 14H. The inner peripheral projections 60 have the same shape. Hereinafter, the shape of only one of the inner peripheral projections 60 will be described. An inner peripheral projection inclined surface 60S is formed at a front end portion of one of both side surfaces 60F1 and 60F2 of the inner peripheral projection 60 in the circumferential direction of the through hole 14H. The inner peripheral projection inclined surface 60S is inclined such that an inner peripheral projection width 60W along the circumferential direction of the through hole 14H becomes smaller toward the front end.

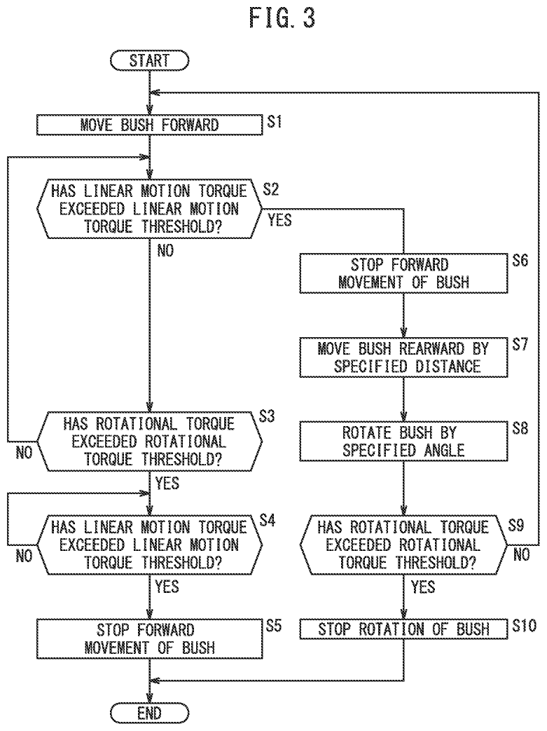

FIG. 3 is a flowchart illustrating a procedure of a control process executed by the motor control unit 28 in order to perform spline-fitting of the screw 12 to the bush 14. This control process is started after the bush 14 has been moved to a predetermined fitting start position spaced apart from the rear end surface of the screw 12 in the rearward direction. At the fitting start position, it is desirable that the rotation center line LN1 (FIG. 2) of the screw 12 and the center line LN2 (FIG. 2) of the through hole 14H of the bush 14 coincide with each other, but the rotation center line LN1 and the center line LN2 may be slightly deviated from each other.

In step S1, the motor control unit 28 moves the bush 14 forward toward the screw 12. When the forward movement of the bush 14 is started, the control process proceeds from step S1 to step S2.

In step S2, the motor control unit 28 compares the linear motion torque detected by the first detection unit 38 during the forward movement of the bush 14 with a predetermined linear motion torque threshold. If the linear motion torque does not exceed the linear motion torque threshold, the control process proceeds to step S3.

In step S3, the motor control unit 28 compares the rotational torque detected by the second detection unit 44 during the forward movement of the bush 14, with a predetermined rotational torque threshold. If the rotational torque does not exceed the rotational torque threshold, the control process returns to step S2. On the other hand, when the rotational torque exceeds the rotational torque threshold, the control process proceeds to step S4. The situation in which the rotational torque exceeds the rotational torque threshold in step S3 occurs in the following state. The first one is a state in which the front end of the inner peripheral projection 60 of the bush 14 is in contact with the outer peripheral projection inclined surface 50S of the screw 12. The second one is a state in which the inner peripheral projection inclined surface 60S of the bush 14 is in contact with the rear end of the outer peripheral projection 50 of the screw 12. The third one is a state in which the inner peripheral projection inclined surface 60S of the bush 14 is in contact with the outer peripheral projection inclined surface 50S of the screw 12.

In step S4, the motor control unit 28 compares the linear motion torque detected by the first detection unit 38 during the forward movement of the bush 14 with the linear motion torque threshold. If the linear motion torque does not exceed the linear motion torque threshold, the control process remains at step S4. On the other hand, when the linear motion torque exceeds the linear motion torque threshold, the control process proceeds to step S5. The situation that the linear motion torque exceeds the linear motion torque threshold in step S4 occurs in the following state. That is, it is a state where the rear end surface of the screw 12 is spline-fitted to the bush 14 by being guided by the outer peripheral projection inclined surface 50S or the inner peripheral projection inclined surface 60S and then the rear end surface of the screw is in contact with the bottom surface of the recess 16A of the bush fastening portion 16.

In Step S5, the motor control unit 28 stops the forward movement of the bush 14 when the linear motion torque exceeds the linear motion torque threshold. When the forward movement of the bush 14 is stopped, the control process ends.

In this way, the motor control unit 28 moves the bush 14 forward until the linear motion torque exceeds the linear motion torque threshold. In a case that the rotational torque exceeds the rotational torque threshold before the linear motion torque exceeds the linear motion torque threshold, the motor control unit 28 ends the control process when the linear motion torque exceeds the linear motion torque threshold. Thus, the spline fitting can be performed by rotating the bush 14 by the guiding action of the outer peripheral projection inclined surface 50S or the inner peripheral projection inclined surface 60S while moving the bush 14 forward. Further, it is possible to grasp that the spline fitting is being performed by the guiding action, based on the rotational torque. Therefore, the spline fitting can be performed without wastefully rotating the bush 14, and as a result, the working efficiency for the spline fitting can be enhanced.

In a case where the linear motion torque exceeds the linear motion torque threshold in step S2 before the rotational torque exceeds the rotational torque threshold, the control process proceeds to step S6. The situation that the linear motion torque exceeds the linear motion torque threshold in step S2 occurs in the following state. That is, the rear end of the outer peripheral projection 50 and the front end of the inner peripheral projection 60 are in contact with each other, or the rear end of the spline-fitted screw 12 is in contact with the bottom surface of the recess 16A of the bush fastening portion 16.

In step S6, the motor control unit 28 stops the forward movement of the bush 14. When the forward movement of the bush 14 is stopped, the control process proceeds to step S7.

In step S7, the motor control unit 28 moves the bush 14 rearward by a specified distance from a position at which the bush 14 has been stopped in step S6. When the rearward movement distance of the bush 14 reaches the specified distance, the control process proceeds to step S8.

In step S8, the motor control unit 28 rotates the bush 14 by a specified angle at the position where the bush 14 has been moved rearward by the specified distance in step S7. When the rotation of the bush 14 is started, the control process proceeds to step S9. When the screw 12 and the bush 14 are spline-fitted to each other, the specified distance is a distance that does not cause the spline-fitting to be disengaged.

In step S9, the motor control unit 28 compares the rotational torque detected by the second detection unit 44 with the rotational torque threshold. The rotational torque detected by the second detection unit 44 is a rotational torque when the bush 14 is rotating with the forward movement of the bush 14 being stopped.

In a case where the rotational torque does not exceed the rotational torque threshold in step S9, the control process returns to step S1. The fact that the rotational torque does not exceed the rotational torque threshold in step S9 means that the rear end surface of the outer peripheral projection 50 and the front end surface of the inner peripheral projection 60 are in contact with each other. Therefore, it is determined in step S2 that the linear motion torque exceeds the linear motion torque threshold. That is, the screw 12 and the bush 14 are not yet spline-fitted to each other.

On the other hand, in a case that the rotational torque exceeds the rotational torque threshold in step S9, the control process proceeds to step S10. The fact that the rotational torque exceeds the rotational torque threshold in step S9 means that the rear end surface of the screw 12 spline-fitted to the bush 14 is in contact with the bottom surface of the recess 16A of the bush fastening portion 16. Therefore, it is determined in step S2 that the linear motion torque exceeds the linear motion torque threshold. That is, the screw 12 and the bush 14 have already been spline-fitted to each other.

In step S10, the motor control unit 28 terminates the control process by stopping the rotation of the bush 14 even if the rotation angle of the bush 14 has not reached the specified angle. Note that in step S10, the motor control unit 28 may end the control process after having moved the bush forward by the specified distance by which the bush was moved rearward in step S7.

As described above, when the rotational torque does not exceed the rotational torque threshold and the linear motion torque exceeds the linear motion torque threshold, the motor control unit 28 rotates the bush 14 by the specified angle after having moved the bush 14 rearward by the specified distance. In this case, when the rotational torque exceeds the rotational torque threshold, the motor control unit 28 ends the control process. As a result, it is possible to correctly detect the spline-fitted state and end the control process.

Instead of rotating the bush 14 by the specified angle after having moved the bush 14 rearward by the specified distance, the motor control unit 28 may rotate the bush 14 by the specified angle while moving the bush 14 rearward by the specified distance. When such a process of rotating the bush 14 by the specified angle while moving the bush 14 rearward by the specified distance is performed, the step S7 and the step S8 are integrated into one step.

On the other hand, when the rotational torque does not exceed the rotational torque threshold even by the rotation of the bush by the specified angle, the motor control unit 28 moves the bush 14 forward until the linear motion torque exceeds the linear motion torque threshold. As a result, it is possible to correctly detect that the spline fitting has not yet been performed and continue the control process.

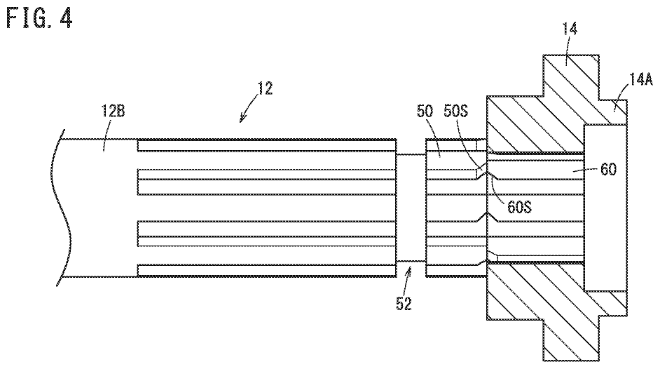

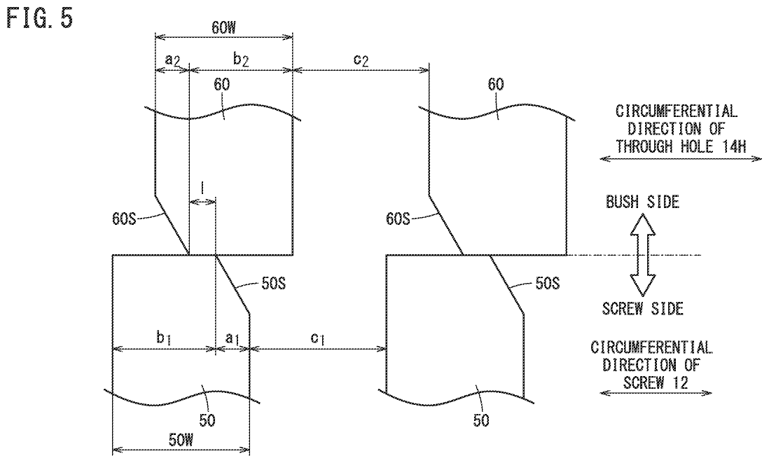

In the present embodiment, the specified angle by which the bush 14 is rotated in step S8 is determined such that the screw 12 and the bushing 14 are spline-fitted to each other by one rotation operation of the bush 14. FIG. 4 is a view showing a state in which the rear end of the outer peripheral projection 50 of the screw 12 and the front end of the inner peripheral projection 60 of the bush 14 are in contact with each other. FIG. 5 is an enlarged view of a contact portion between the rear end of the outer peripheral projection 50 and the front end of the inner peripheral projection 60 shown in FIG. 4.

The specified angle is determined so as to satisfy the relationship of the following Inequality (1). In Inequality (1), a₁ is the length of the outer peripheral projection inclined surface 50S along the circumferential direction of the screw 12. In Inequality (1), b₁ is the length of the rear end surface of the outer peripheral projection 50 along the circumferential direction of the screw 12. In Inequality (1), b₂ is the length of the front end surface of the inner peripheral projection 60 along the circumferential direction of the through hole 14H. In Inequality (1), c₁ is the interval between the outer peripheral projections 50 along the circumferential direction of the screw 12. In Inequality (1), c₂ is the interval between the inner peripheral projections 60 along the circumferential direction of the through hole 14H. In Inequality (1), X is a value obtained by multiplying a radius r (FIG. 2) from the center line LN2 (FIG. 2) of the through hole 14H to the front end of the inner peripheral projection 60 by the specified angle. Incidentally, a₁ and b₁ have a relation of a₁+b₁=50W. In addition, a₂ and b₂ have a relation of a₂+b₂=60W. a₂ is the length of the inner peripheral projection inclined surface 60S along the circumferential direction of the through hole 14H.

b₁+b₂<X<a₁+c₁−b₂ (1)

By satisfying Inequality (1), the screw 12 and the bush 14 can be spline-fitted to each other by one rotation operation of the bush 14 with respect to the screw 12.

### [Modifications]

The above embodiment may be modified as follows.

### (Modification 1)

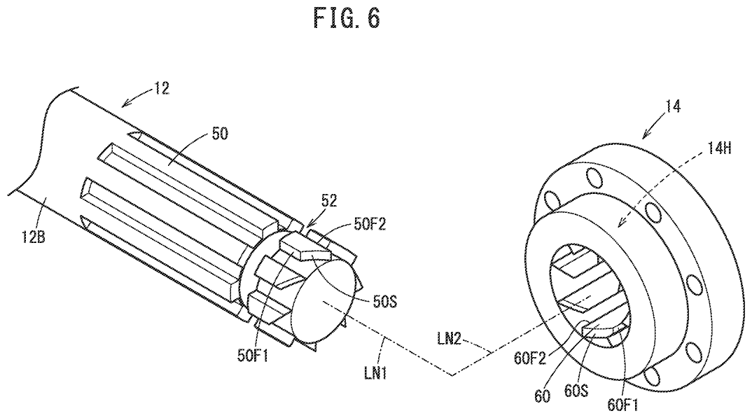

FIG. 6 is a view showing a screw 12 and a bush 14 according to a first modification. In FIG. 6, the same reference numerals are used to designate constituent elements that are the same as those described in the embodiment. Moreover, in the present modification, descriptions that overlap or are duplicative of those stated in the embodiment will be omitted.

In the present modification, the rear end of the outer peripheral projection 50 of the screw 12 is formed in a pointed shape or a rounded shape. That is, the rear end of the outer peripheral projection 50 of the screw 12 has no flat surface. In addition, there is no plane orthogonal to the rotation center line LN1 (FIG. 2) of the screw 12 at the rearmost end of the screw 12. Further, the front end of the inner peripheral projection 60 of the bush 14 is formed in a pointed shape or a rounded shape. That is, there is no flat surface at the front end of the inner peripheral projection 60 of the bush 14. In addition, there is no plane orthogonal to the center line LN2 (FIG. 2) of the through hole 14H of the bush 14 at the foremost end of the bush 14. In the case of the present modification, b₁ and b₂ in the above Inequality (1) are 0.

With the above configuration, it is possible to avoid a situation in which the bush 14 fails to move forward due to contact between the rear end surface of the outer peripheral projection 50 and the front end surface of the inner peripheral projection 60. Therefore, it is possible to further enhance the certainty with which spline fitting can be performed, as compared with the embodiment.

### (Modification 2)

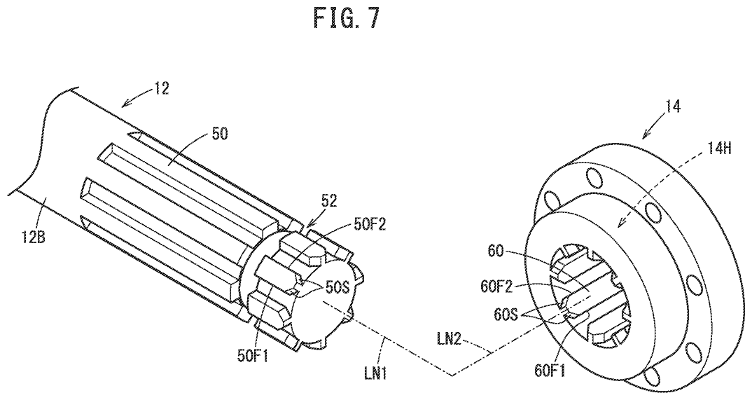

FIG. 7 is a view showing a screw 12 and a bush 14 according to a second modification. In FIG. 7, the same reference numerals are used to designate constituent elements that are the same as those described in the embodiment. Moreover, in the present modification, descriptions that overlap or are duplicative of those stated in the embodiment will be omitted.

In the present modification, the outer peripheral projection inclined surface 50S of the outer peripheral projection 50 is formed on each of both side surfaces 50F1 and 50F2 in the circumferential direction of the screw 12. In addition, in the present modification, the inner peripheral projection inclined surface 60S of the inner peripheral projection 60 is formed on each of both side surfaces 60F1 and 60F2 in the circumferential direction of the through hole 14H.

In the case of the present modification, the a₁ in the above Inequality (1) is the sum of the lengths, along the circumferential direction of the screw 12, of the outer peripheral projection inclined surfaces 50S formed on the respective both side surfaces 50F1 and 50F2 of the outer peripheral projection 50.

In this modification, similarly to the embodiment, the screw 12 and the bush 14 can be spline-fitted to each other by one rotation operation of the bush 14 with respect to the screw 12.

### (Modification 3)

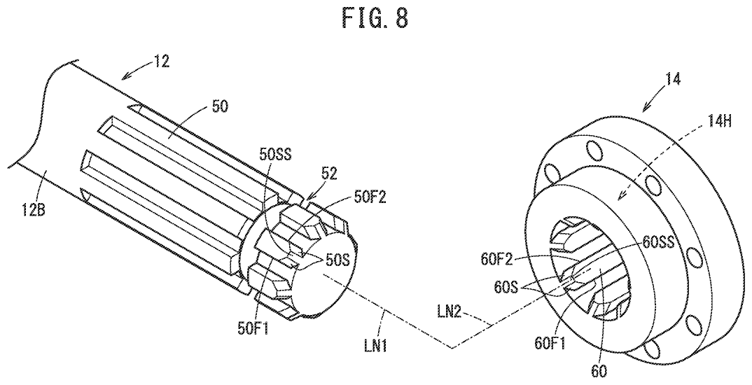

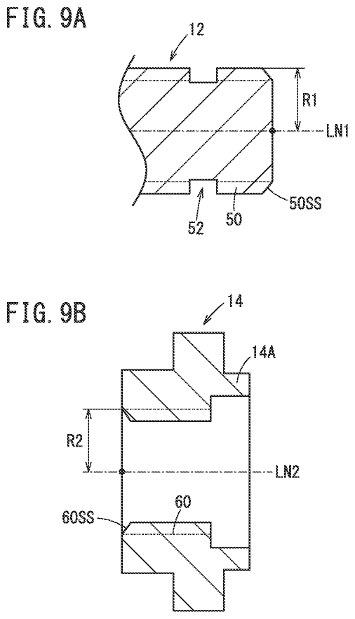

FIG. 8 is a view showing a screw 12 and a bush 14 according to a third modification. FIG. 9A is a cross sectional view of the screw 12 of FIG. 8. FIG. 9B is a cross sectional view of the bush 14 of FIG. 8. In FIGS. 8, 9A, and 9B, the same reference numerals are used to designate constituent elements that are the same as those described in the embodiment. Moreover, in the present modification, descriptions that overlap or are duplicative of those stated in the embodiment will be omitted.

In addition to the outer peripheral projection inclined surface 50S of the second modification, a second outer peripheral projection inclined surface 50SS is formed in the outer peripheral projection 50 of the present modification. The second outer peripheral projection inclined surface 50SS is inclined such that the outer diameter of the screw 12 gradually decreases toward the rear end of the outer peripheral projection 50. That is, the second outer peripheral projection inclined surface 50SS is inclined such that the radius R1 (FIG. 9A) of the screw 12 from the rotation center line LN1 of the screw 12 gradually decreases toward the rear end of the outer peripheral projection 50.

In addition to the inner peripheral projection inclined surface 60S of the second modification, a second inner peripheral projection inclined surface 60SS is formed on the inner peripheral projection 60 of the present modification. The second inner peripheral projection inclined surface 60SS is inclined such that the inner diameter of the bush 14 gradually increases toward the front end of the inner peripheral projection 60. In other words, the second inner peripheral projection inclined surface 60SS is inclined such that the radius R2 (FIG. 9B) of the through hole 14H from the center line LN2 of the through hole 14H gradually increases toward the front end of the inner peripheral projection 60.

With the above configuration, it is possible to reduce a situation in which the bush 14 fails to move forward due to contact between the rear end surface of the outer peripheral projection 50 and the front end surface of the inner peripheral projection 60. Therefore, it is possible to further enhance certainty with which spline fitting can be performed as compared with a case where neither the second outer peripheral projection inclined surface 50SS nor the second inner peripheral projection inclined surface 60SS are formed.

### (Modification 4)

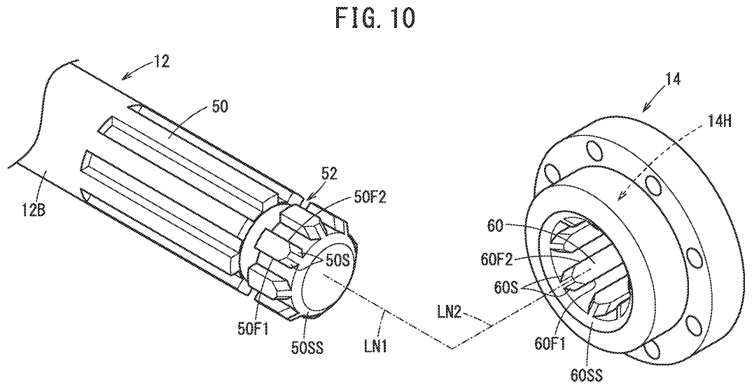

FIG. 10 is a view showing a screw 12 and a bush 14 according to a fourth modification. In FIG. 10, the same reference numerals are used to designate constituent elements that are the same as those described in the embodiment. Moreover, in the present modification, descriptions that overlap or are duplicative of those stated in the embodiment will be omitted.

In the present modification, the second outer peripheral projection inclined surface 50SS is formed not only on each of the outer peripheral projections 50 but also between the outer peripheral projections 50. Further, the second inner peripheral projection inclined surface 60SS is formed not only on each of the inner peripheral projections 60 but also between the inner peripheral projections 60. With this configuration, spline fitting can be performed even when the bush 14 moves forward in a state in which the center line LN2 of the through hole 14H of the bush 14 is displaced in the radial direction of the screw 12 away from the rotation center line LN1 of the screw 12.

The second outer peripheral projection inclined surface 50SS disposed between the side surface and the rear end surface of the screw 12 may be formed over the entire circumference around the axis of the screw 12 (see FIG. 10). Similarly, the second inner peripheral projection inclined surface 60SS disposed between the inner peripheral surface and the front end surface of the bush 14 may be formed over the entire circumference around the axis of the bush 14 (see FIG. 10). Further, the second outer peripheral projection inclined surface 50SS may be formed only between the outer peripheral projections 50. Similarly, although not illustrated, the second inner peripheral projection inclined surface 60SS may be formed only between the inner peripheral projections 60.

### (Modification 5)

The rear end of the outer peripheral projection 50 may be located on the same plane as the rear end surface of the screw 12 or may be located forward of the rear end surface of the screw 12. That is, the rear end of the outer peripheral projection 50 in the embodiment and the first to third modifications may be located forward of the rear end surface of the screw 12 as in the fourth modification. The rear end of the outer peripheral projection 50 in the fourth modification may be positioned on the same plane as the rear end surface of the screw 12 as in the embodiment and the first to third modifications.

The front end of the inner peripheral projection 60 may be located on the same plane as the front end surface of the bush 14 or may be located rearward of the front end surface of the bush 14. That is, the front end of the inner peripheral projection 60 in the embodiment and the first to third modifications may be located rearward of the front end surface of the bush 14 as in the fourth modification. The front end of the inner peripheral projection 60 in the fourth modification may be located on the same plane as the front end surface of the bush 14 as in the embodiment and the first to third modifications.

### (Modification 6)

The above-described embodiment and the modifications thereof may be optionally combined within a range in which no technical inconsistencies occur.

The inventions that can be grasped from the above-described embodiment and the modifications thereof will be described below.

A first invention is characterized by the injection device (10) including the screw (12) disposed along the forward and rearward direction including the forward direction in which the injection resin is injected and the rearward direction opposite to the forward direction, and the bush (14) formed so as to be spline-fitted to the screw, the injection device causing the screw and the bush to be spline-fitted to each other, the injection device (10) further including: the linear motion motor (24) configured to move the bush forward and rearward in the forward and rearward direction with respect to the screw; the rotary motor (26) configured to rotate the bush with respect to the screw; the first detection unit (38) configured to detect the linear motion torque of the linear motion motor; the second detection unit (44) configured to detect the rotational torque of the rotary motor; and the motor control unit (28) configured to execute the control process of controlling the linear motion motor and the rotary motor while monitoring the linear motion torque and the rotational torque in a manner so that the bush is spline-fitted to the screw, wherein the screw includes the outer peripheral projections (50) formed on the outer peripheral surface on the rear end side of the screw, the outer peripheral projections extending along the forward and rearward direction and being formed at intervals in the circumferential direction of the screw, each of the outer peripheral projections is formed with the outer peripheral projection inclined surface (50S) inclined in a manner so that the outer peripheral projection width (50W) along the circumferential direction of the screw becomes smaller toward the rear end, the bush includes the through hole (14H) extending in the forward and rearward direction, and the inner peripheral projections (60) formed on the inner peripheral surface of the through hole, the inner peripheral projections extending in the forward and rearward direction and being formed at intervals in the circumferential direction of the through hole, each of the inner peripheral projections is formed with the inner peripheral projection inclined surface (60S) inclined in a manner so that the inner peripheral projection width (60W) along the circumferential direction of the through hole becomes smaller toward the front end, and the motor control unit moves the bush forward until the linear motion torque exceeds the linear motion torque threshold, and in a case where the rotational torque exceeds the rotational torque threshold before the linear motion torque exceeds the linear motion torque threshold, the motor control unit ends the control process when the linear motion torque exceeds the linear motion torque threshold.

With this configuration, the spline fitting can be performed by rotating at least one of the bush or the screw by the guiding action of the outer peripheral projection inclined surface or the inner peripheral projection inclined surface while moving at least one of the bush or the screw forward. Further, it is possible to grasp that the spline fitting is being performed by the guiding action, based on the rotational torque. Therefore, the spline fitting can be performed without wastefully rotating the bush, and as a result, the working efficiency for the spline fitting can be enhanced.

In a case where the rotational torque does not exceed the rotational torque threshold and the linear motion torque exceeds the linear motion torque threshold, the motor control unit may move the bush rearward by a specified distance and rotates the bush by a specified angle, and, in a case where the rotational torque exceeds the rotational torque threshold due to rotation of the bush by the specified angle, the motor control unit may end the control process.

With this configuration, it is possible to correctly detect the spline-fitted state and end the control process.

In a case where the rotational torque does not exceed the rotational torque threshold even by the rotation of the bush by the specified angle, the motor control unit may move the bush forward until the linear motion torque exceeds the linear motion torque threshold.

With this configuration, it is possible to correctly detect that the spline fitting has not yet been completed and continue the control process.

When the length of the outer peripheral projection inclined surface in the circumferential direction of the screw is defined as a₁, the length of the inner peripheral projection inclined surface in the circumferential direction of the through hole is defined as a₂, the length of the rear end surface of the outer peripheral projection in the circumferential direction of the screw is defined as b₁ the length of the front end surface of the inner peripheral projection in the circumferential direction of the through hole is defined as b₂, the interval between the outer peripheral projections in the circumferential direction of the screw is defined as c₁, the interval between the inner peripheral projections in the circumferential direction of the through hole is defined as c₂, and a value obtained by multiplying the radius (r) from the center line (LN2) of the through hole to the front end of the inner peripheral projection by the specified angle is defined as X, the specified angle is determined so as to satisfy the relationship of b₁+b₂<X<a₁+c₁−b₂.

With this configuration, the screw and the bush can be spline-fitted to each other by one rotation operation of the bush with respect to the screw.

The second outer peripheral projection inclined surface (50SS) inclined in a manner so that the outer diameter of the screw becomes smaller toward the rear end, may be formed on the rear end side of the screw, and the second inner peripheral projection inclined surface (60SS) inclined in a manner so that the inner diameter of the bush becomes larger toward the front end, may be formed on the front end side of the bush.

With this configuration, it is possible to reduce a situation in which the rear end surface of the outer peripheral projection and the front end surface of the inner peripheral projection come into contact with each other and the bush consequently does not move forward. Therefore, it is possible to further enhance certainty with which spline fitting can be performed as compared with a case where the second outer peripheral projection inclined surface and the second inner peripheral projection inclined surface are not formed.

The second outer peripheral projection inclined surface may be formed on each of the outer peripheral projections, and the second inner peripheral projection inclined surface may be formed on each of the inner peripheral projections.

With this configuration, it is possible to further enhance certainty with which spline fitting can be performed as compared with a case where neither the second outer peripheral projection inclined surface nor the second inner peripheral projection inclined surface are formed on the outer peripheral projection and the inner peripheral projection.

The second outer peripheral projection inclined surface may be formed between the outer peripheral projections, and the second inner peripheral projection inclined surface may be formed between the inner peripheral projections.

With this configuration, it is possible to further enhance certainty with which spline fitting can be performed as compared with a case where neither the second outer peripheral projection inclined surface nor the second inner peripheral projection inclined surface are formed between the outer peripheral projections and between the inner peripheral projections.

A second invention is characterized by the control method executed by the injection device, the injection device including: the screw disposed along the forward and rearward direction including the forward direction in which the injection resin is injected and the rearward direction opposite to the forward direction; the bush formed so as to be spline-fitted to the screw; the linear motion motor configured to move the bush forward and rearward in the forward and rearward direction with respect to the screw; the rotary motor configured to rotate the bush with respect to the screw; the first detection unit configured to detect the linear motion torque of the linear motion motor; and the second detection unit configured to detect the rotational torque of the rotary motor, and in the control method, the injection device controls the linear motion motor and the rotary motor while monitoring the linear motion torque and the rotational torque in a manner so that the screw and the bush are spline-fitted to each other, the control method including: the forward movement step of moving the bush forward until the linear motion torque exceeds the linear motion torque threshold; the forward movement stopping step of, in a case where the rotational torque exceeds the rotational torque threshold before the linear motion torque exceeds the linear motion torque threshold, stopping forward movement of the bush when the linear motion torque exceeds the linear motion torque threshold, wherein the screw includes the outer peripheral projections formed on the outer peripheral surface on the rear end side of the screw, the outer peripheral projections extending along the forward and rearward direction and being formed at intervals in the circumferential direction of the screw, each of the outer peripheral projections is formed with the outer peripheral projection inclined surface inclined in a manner so that the outer peripheral projection width along the circumferential direction of the screw becomes smaller toward the rear end, the bush includes the through hole, and the inner peripheral projections formed on the inner peripheral surface of the through hole, the inner peripheral projections extending in the forward and rearward direction and being formed at intervals in the circumferential direction of the through hole, and each of the inner peripheral projections is formed with the inner peripheral projection inclined surface inclined in a manner so that the inner peripheral projection width along the circumferential direction of the through hole becomes smaller toward the front end.

With this configuration, the spline fitting can be performed by rotating at least one of the bush or the screw by the guiding action of the outer peripheral projection inclined surface or the inner peripheral projection inclined surface while moving at least one of the bush or the screw forward. Further, it is possible to grasp that the spline fitting is being performed by the guiding action, based on the rotational torque. Therefore, the spline fitting can be performed without wastefully rotating the bush, and as a result, the working efficiency for the spline fitting can be enhanced.

The control method may further include: the rearward movement and rotation step of moving the bush rearward by the specified distance and rotating the bush by the specified angle when the rotational torque does not exceed the rotational torque threshold and the linear motion torque exceeds the linear motion torque threshold; and the second forward movement stopping step of stopping forward movement of the bush when the rotational torque exceeds the rotational torque threshold due to rotation of the bush by the specified angle.

With this configuration, it is possible to correctly detect the spline-fitted state and end the control process.

The control method may further include returning to the forward movement step in a case where the rotational torque does not exceed the rotational torque threshold even by the rotation of the bush by the specified angle.

With this configuration, it is possible to correctly detect that the spline fitting has not yet been completed and continue the control process.

1. An injection device comprising a screw disposed along a forward and rearward direction including a forward direction in which an injection resin is injected and a rearward direction opposite to the forward direction, and a bush formed so as to be spline-fitted to the screw, the injection device causing the screw and the bush to be spline-fitted to each other, the injection device further comprising:
a linear motion motor configured to move the bush forward and rearward in the forward and rearward direction with respect to the screw;
a rotary motor configured to rotate the bush with respect to the screw;
a first detection unit configured to detect a linear motion torque of the linear motion motor;
a second detection unit configured to detect a rotational torque of the rotary motor; and
a motor control unit configured to execute a control process of controlling the linear motion motor and the rotary motor while monitoring the linear motion torque and the rotational torque in a manner so that the bush is spline-fitted to the screw,
wherein
the screw includes a plurality of outer peripheral projections formed on an outer peripheral surface on a rear end side of the screw, the outer peripheral projections extending along the forward and rearward direction and being formed at intervals in a circumferential direction of the screw,
each of the outer peripheral projections is formed with an outer peripheral projection inclined surface inclined in a manner so that an outer peripheral projection width along the circumferential direction of the screw becomes smaller toward a rear end,
the bush includes a through hole extending in the forward and rearward direction, and a plurality of inner peripheral projections formed on an inner peripheral surface of the through hole, the inner peripheral projections extending in the forward and rearward direction and being formed at intervals in a circumferential direction of the through hole,
each of the inner peripheral projections is formed with an inner peripheral projection inclined surface inclined in a manner so that an inner peripheral projection width along the circumferential direction of the through hole becomes smaller toward a front end, and
the motor control unit moves the bush forward until the linear motion torque exceeds a linear motion torque threshold, and in a case where the rotational torque exceeds a rotational torque threshold before the linear motion torque exceeds the linear motion torque threshold, the motor control unit ends the control process when the linear motion torque exceeds the linear motion torque threshold.

2. The injection device according to claim 1, wherein
when the rotational torque does not exceed the rotational torque threshold and the linear motion torque exceeds the linear motion torque threshold, the motor control unit moves the bush rearward by a specified distance and rotates the bush by a specified angle, and, when the rotational torque exceeds the rotational torque threshold due to rotation of the bush by the specified angle, the motor control unit ends the control process.

3. The injection device according to claim 2, wherein
when the rotational torque does not exceed the rotational torque threshold even by the rotation of the bush by the specified angle, the motor control unit moves the bush forward until the linear motion torque exceeds the linear motion torque threshold.

4. The injection device according to claim 2, wherein
when a length of the outer peripheral projection inclined surface in the circumferential direction of the screw is defined as a₁, a length of the inner peripheral projection inclined surface in the circumferential direction of the through hole is defined as a₂, a length of a rear end surface of each of the outer peripheral projections in the circumferential direction of the screw is defined as b₁, a length of a front end surface of each of the inner peripheral projections in the circumferential direction of the through hole is defined as b₂, an interval between the outer peripheral projections in the circumferential direction of the screw is defined as c₁, an interval between the inner peripheral projections in the circumferential direction of the through hole is defined as c₂, and a value obtained by multiplying a radius from a center line of the through hole to a front end of each of the inner peripheral projections by the specified angle is defined as X,
the specified angle is determined so as to satisfy a relationship of b₁+b₂<X<a₁+c₁−b₂.

5. The injection device according to claim 1, wherein
a second outer peripheral projection inclined surface inclined in a manner so that an outer diameter of the screw becomes smaller toward the rear end, is formed on the rear end side of the screw, and
a second inner peripheral projection inclined surface inclined in a manner so that an inner diameter of the bush becomes larger toward the front end, is formed on a front end side of the bush.

6. The injection device according to claim 5, wherein
the second outer peripheral projection inclined surface is formed on each of the outer peripheral projections, and
the second inner peripheral projection inclined surface is formed on each of the inner peripheral projections.

7. The injection device according to claim 5, wherein
the second outer peripheral projection inclined surface is formed between the outer peripheral projections, and
the second inner peripheral projection inclined surface is formed between the inner peripheral projections.

8. A control method executed by an injection device,
wherein the injection device includes:
a screw disposed along a forward and rearward direction including a forward direction in which an injection resin is injected and a rearward direction opposite to the forward direction;
a bush formed so as to be spline-fitted to the screw;
a linear motion motor configured to move the bush forward and rearward in the forward and rearward direction with respect to the screw;
a rotary motor configured to rotate the bush with respect to the screw;
a first detection unit configured to detect a linear motion torque of the linear motion motor; and
a second detection unit configured to detect a rotational torque of the rotary motor, and
in the control method, the injection device controls the linear motion motor and the rotary motor while monitoring the linear motion torque and the rotational torque in a manner so that the screw and the bush are spline-fitted to each other, the control method comprising:
a forward movement step of moving the bush forward until the linear motion torque exceeds a linear motion torque threshold;
a forward movement stopping step of, in a case where the rotational torque exceeds a rotational torque threshold before the linear motion torque exceeds the linear motion torque threshold, stopping forward movement of the bush when the linear motion torque exceeds the linear motion torque threshold,
wherein
the screw includes a plurality of outer peripheral projections formed on an outer peripheral surface on a rear end side of the screw, the outer peripheral projections extending along the forward and rearward direction and being formed at intervals in a circumferential direction of the screw,
each of the outer peripheral projections is formed with an outer peripheral projection inclined surface inclined in a manner so that an outer peripheral projection width along the circumferential direction of the screw becomes smaller toward a rear end,
the bush includes a through hole, and a plurality of inner peripheral projections formed on an inner peripheral surface of the through hole, the inner peripheral projections extending in the forward and rearward direction and being formed at intervals in a circumferential direction of the through hole, and
each of the inner peripheral projections is formed with an inner peripheral projection inclined surface inclined in a manner so that an inner peripheral projection width along the circumferential direction of the through hole becomes smaller toward a front end.

9. The control method according to claim 8, further comprising:
a rearward movement and rotation step of moving the bush rearward by a specified distance and rotating the bush by a specified angle when the rotational torque does not exceed the rotational torque threshold and the linear motion torque exceeds the linear motion torque threshold; and
a second forward movement stopping step of stopping forward movement of the bush when the rotational torque exceeds the rotational torque threshold due to rotation of the bush by the specified angle.

10. The control method according to claim 9, further comprising:
returning to the forward movement step when the rotational torque does not exceed the rotational torque threshold even by the rotation of the bush by the specified angle.
